(19) United States
(12) Patent Application Publication
(10) Pub. No.: US 2015/0271540 A1
(43) Pub. Date: Sep. 24, 2015

(54) Audience-Based Television Advertising Transaction Engine

(71) Applicant: clypd, inc., Somerville, MA (US)

(72) Inventors: Joel C. Melby, Southborough, MA (US); Jason M. Burke, Chestnut Hill, MA (US); Lillian M. Carrasquillo, Somerville, MA (US); Ajay H. Daptardar, Belmont, MA (US); Marco A. Montes de Oca, Arlington, MA (US); Jeffrey W. Walker, Boston, MA (US)

(73) Assignee: CLYPD, INC., Somerville, MA (US)

(21) Appl. No.: 14/663,703

(22) Filed: Mar. 20, 2015

Related U.S. Application Data
(60) Provisional application No. 61/982,014, filed on Apr. 21, 2014.
(60) Provisional application No. 61/968,497, filed on Mar. 21, 2014.

(51) Int. Cl. H04N 21/2668; H04N 21/258; H04N 21/81; H04N 21/25

(52) U.S. Cl. CPC H04N 21/2668; H04N 21/252; H04N 21/25883; H04N 21/25891; H04N 21/812

(57) ABSTRACT

A computer system provides a virtual marketplace in which an advertising opportunity (such as a television advertising opportunity) is expressed in terms of an audience model representing an audience associated with the advertising opportunity. The computer system provides potential buyers of a particular advertising opportunity with information about the audience model associated with that advertising opportunity. The computer system sells advertising opportunities to buyers using any of a variety of transaction semantics. A buyer who purchases a particular advertising opportunity purchases the opportunity to present an advertisement to an audience represented by the audience model associated with the purchased advertising opportunity.

### BACKGROUND

### Related Art

Advertising buyers purchase advertisement placement opportunities (such as television advertisement placement opportunities) for the purpose of targeting advertisements at audiences who are likely to purchase the products and services advertised by such advertisements. Information about the attributes of the targeted audience, therefore, is highly relevant to the purchasing decisions of advertisement buyers. Traditionally, however, it has been difficult to generate highly specific information about the audience that is likely to view a particular television program and that therefore is likely to view advertisements within that television program. As a result, traditionally only relatively general information about the expected audience for television advertising opportunities, such as the age and gender of the expected audience, has been provided to advertising buyers when offering television advertising opportunities for sale. Advertisement buyers, therefore, have needed to draw inferences from the vague and limited information provided to them by advertisement sellers in an attempt to predict the audience that is likely to view purchased advertising opportunities. Such inferences are difficult to make with high accuracy. As a result, the traditional process of selling and purchasing television advertisement placement opportunities has been fraught with imperfect information about the audiences associated with advertising opportunities. Such imperfect information can act to the detriment of both buyers, who may purchase the wrong advertising opportunities or overpay for purchased opportunities, and sellers, who may sell opportunities at suboptimal prices.

### SUMMARY

One embodiment of the present invention includes a computer system which generates a predictive model of an audience for content (e.g., television program and/or advertisement content). The model may be generated based on a variety of sources, such as one or more of the following: audience regression models such as those provided by Rentrak and Nielsen, third-party household profiles, aggregated demographic and/or behavioral data (at one or more of the ZIP code, metro, state, and regional levels) obtained from the U.S. Census Bureau and/or third parties, return-path data from television service provider set-top boxes, and automatic content recognition (ACR) data from connected televisions. The audience model may describe the associated audience in terms of any of a variety of attributes, such as one or more of the following: location, demography, psychography, and behavior. The audience model may be used for any of a variety of purchases, such as selling advertisements.

Another embodiment of the present invention provides a virtual marketplace in which an advertising opportunity (such as a television advertising opportunity) is expressed in terms of an audience model representing an audience associated with the advertising opportunity, such as the audience model described above. The system provides potential buyers of a particular advertising opportunity with information about the audience model associated with that advertising opportunity. The system sells advertising opportunities to buyers using any of a variety of transaction semantics. A buyer who purchases a particular advertising opportunity purchases the opportunity to present an advertisement to an audience represented by the audience model associated with the purchased advertising opportunity.

For example, one embodiment of the present invention is directed to a method performed by at least one computer processor executing computer program instructions stored on at least one non-transitory computer-readable medium. The method comprises: (A) generating an audience model representing at least one attribute of an audience associated with particular television content, the audience model including first audience attribute data representing at least one value of at least one attribute of the audience associated with the television content; (B) generating opportunity data representing an advertisement placement opportunity associated with the television content, wherein the opportunity data includes second audience attribute data derived from the first audience attribute data; and (C) generating opportunity output based on the opportunity data, wherein the opportunity output includes third audience attribute data derived from the second audience attribute data.

Other features and advantages of various aspects and embodiments of the present invention will become apparent from the following description and from the claims.

### BRIEF DESCRIPTION OF THE DRAWINGS

FIG. 1 is dataflow diagram of a system for generating a predictive audience model according to one embodiment of the present invention;

FIG. 2 is a flowchart of a method performed by the system of FIG. 1 according to one embodiment of the present invention;

FIG. 3 is a dataflow diagram of a system for representing and expressing advertising opportunities in terms of audience models representing audiences associated with those advertising opportunities according to one embodiment of the present invention; and

FIG. 4 is a flowchart of a method performed by the system of FIG. 1 according to one embodiment of the present invention.

### DETAILED DESCRIPTION

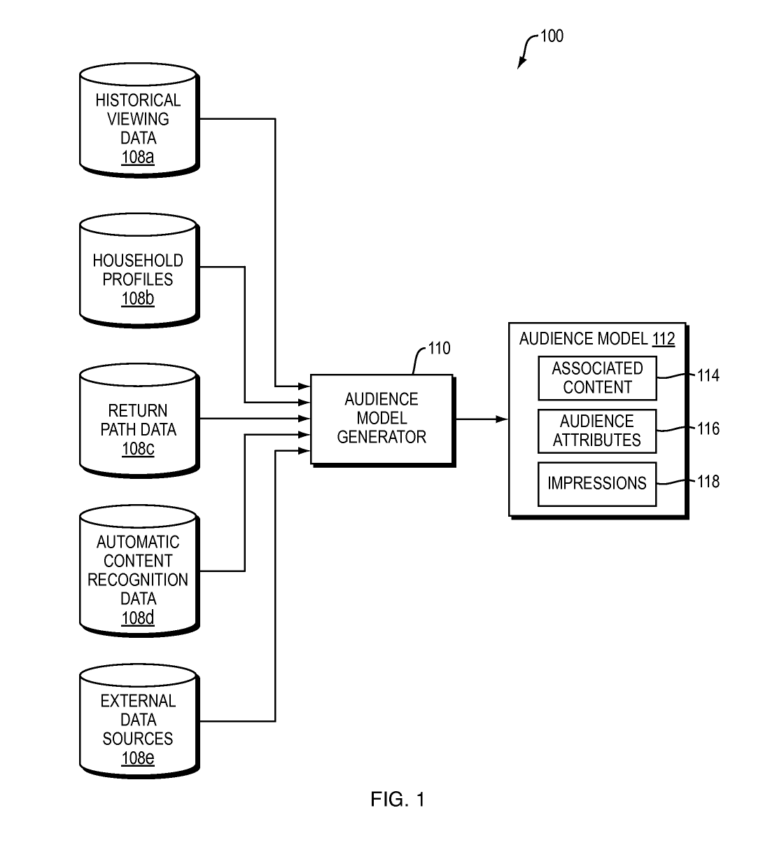

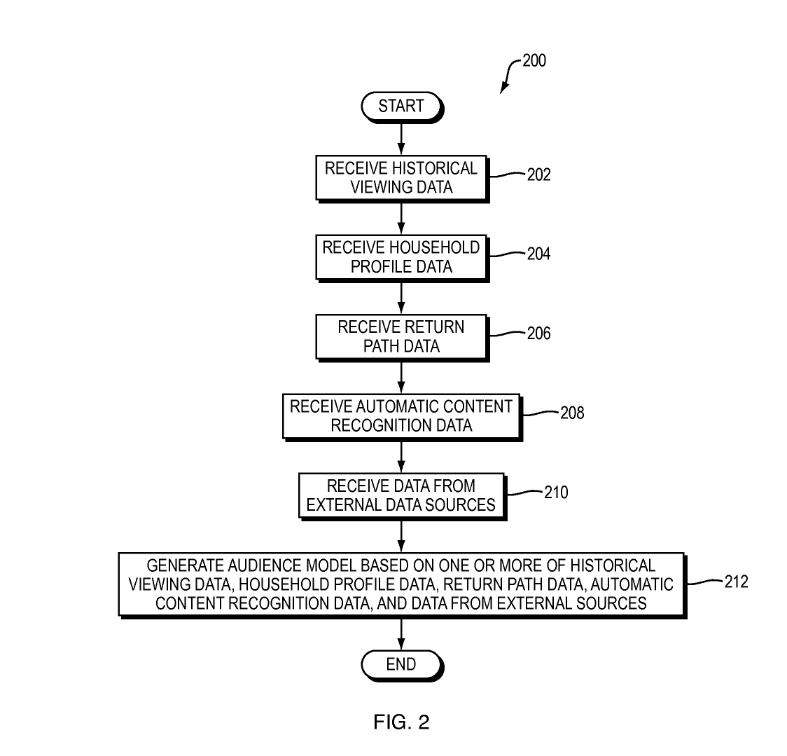

In one embodiment, a computer system generates a predictive model of an audience for content. The content may, for example, be a television program, online content (such as an online streaming video), an advertisement, or any combination thereof. For example, referring to FIG. 1, a dataflow diagram is shown of a system 100 for generating a predictive audience model according to one embodiment of the present invention. Referring to FIG. 2, a flowchart is shown of a method 200 performed by the system 100 according to one embodiment of the present invention.

The system 100 includes an audience model generator 110. The audience model generator 110 receives as input any of a variety of inputs, such as one or more of the following: (1) historical viewing data 108a (FIG. 2, operation 202); (2) third-party household profile data 108b (FIG. 2, operation 204); (3) return path data 108c (FIG. 2, operation 206); (4) automatic content recognition (ACR) data 108d (FIG. 2, operation 208); and (5) data 108e received from external sources (FIG. 2, operation 210). The audience model generator 110 generates an audience model 112 based on one or more of the inputs to the audience model generator 110 (such as one or more of inputs 108a-e) (FIG. 2, operation 212).

The historical viewing data models 108a may, for example, be of the kind provided by services such as Rentrak and Nielsen. The historical viewing data models 108a may include any of a variety of information, such as data representing:
The average number of televisions tuned into a particular program or a particular network during a particular time frame.
The number of unique households reporting at least one minute of viewing for the selected time frame and classification. Permissible classifications may include, for example, “telecast” and “network.”
The average percentage of households using television during a particular time frame, out of the market universe.
The percentage of the available audience that viewed a network, series, or telecast.
The average audience of a particular program relative to the total average audience across all programming during the same time frame.
The number of unique set top boxes reporting at least one minute of viewing for a selected time frame and classification.

The data listed above are merely examples and do not constitute limitations of the present invention. The historical viewing data models 108a may include, for example, any data provided by Rentrak, Nielsen, or similar services.

The household profiles 108b may include any of a variety of data descriptive of one or more households, such as data of the kind provided by companies such as Acxiom, Experian, Epsilon, and Polk, which collect data from sources such as credit card companies and the census. The particular household profiles provided by these companies are merely examples and do not constitute limitations of the present invention. More generally, the household profiles 108b may include data descriptive of one or more households contained from any of a variety of sources. Each of the household profiles 108b may, for example, include a household identifier (ID) which uniquely identifies the household represented by that household profile. As this implies, each of the household profiles 108b may have a unique household ID.

The return path data 108c may include data received from one or more set-top boxes. The return path data 108c may include, for example, data indicating which channel a particular set-top box is tuned to at a particular point in time. In general, the return path data 108c from a particular set-top box may include any data descriptive of the behavior of users of that set-top box. Such data 108c may, for example, include data descriptive of the state(s) of the set-top box, inputs provided to the set-top box, outputs provided by the set-top box, and actions performed by the set-top box. The return path data 108c associated with (e.g., received from) a particular set-top box may include a set-top box identifier (ID) which uniquely identifies the set-top box. Such a set-top box ID may be correlated (e.g., by the audience model generator 110 or other component of the system 100) with household IDs in the household profiles 108b to identify which set-top box (and corresponding data in the return path data 108c) is associated with a particular household profile and/or which household profile(s) is/are associated with a particular set-top box (and corresponding data in the return path data 108c). This is one way in which the system 100 of FIG. 1 may determine who (e.g., which household or individual within a household) is or was watching particular content specified by the return path data 108c.

The automatic content recognition (ACR) data 108d may include any data which identifies one or more content elements (such as elements of television content). The ACR data 108d may be generated, for example, by a client application (such as a client application executing on a set-top box, television, or computing device) which samples a portion of content (such as an element within content being rendered by the client application), processing the sample, and comparing it with a reference service that identifies content by its unique characteristics, such as audio or video fingerprints or watermarks. The ACR data 108d may, for example, indicate that a particular 5-minute segment of corresponding content is a segment of the Glee television program. As another example, the ACR data 108d may indicate that a particular 30-second segment of corresponding content is a particular advertisement. The ACR data 108d may include such identifying data for any number of content elements. The ACR data 108d may include ACR data received from any source(s), such as set-top boxes, televisions, smartphones, and computers.

The data 108e from external sources may include any of a variety of data, such as economic data (e.g., any one or more of stock market indices, gross domestic product (GDP), and unemployment rates) and environmental data (e.g., any one or more of historical weather data, weather predictions, historical climate data, and climate predictions). As these examples illustrate, the external data 108e may include statistical data which is not related explicitly to viewers, but instead to external phenomena. As described in more detail below, embodiments of the present invention may correlate such external data with viewer-related data to generate the audience model 112.

The historical viewing data models 108a, household profiles 108b, return path data 108c, ACR data 108d, and external data 108e may be transmitted to the system 100 via any communications medium or media, such as telephone, mobile (e.g., SMS), radio, digital subscriber line, cable, or any combination thereof. Such data 108a-e may be transmitted to the system over IP via an Internet connection. The various data 108a-e may be transmitted to the system 100 using the same or different media and/or protocols. For example, the return path data 108c may be transmitted to the system 100 via telephone lines, which the ACR data 108d may be transmitted to the system 100 via cable.

As mentioned above, the audience model generator 110 may generate the audience model 112 based on some or all of the data 108a-e in any of a variety of ways. In general, the audience model 112 contains data representing attributes of an expected audience associated with particular content, such as television content. For example, the audience model 112 may contain data representing attributes of an audience that is expected to watch a particular television program. Additionally or alternatively, the audience model 112 may contain historical audience model data, such as previously-generated estimates of audience attributes and/or previously-received data from one or more of the historical viewing data models 108a, household profiles 108b, return path data 108c, and ACR data 108d.

The audience model generator 110 may include, in the audience model 112, data 114 specifying the particular content associated with the audience model 112. The associated content data 114 may represent the associated content in any of a variety of ways, such as by specifying one or more identifiers of the associated content, such as data representing one or more of the following: the name of the associated content (e.g., the name of a particular television program), the network (e.g., television network) or other distribution mechanism that broadcast or otherwise delivered the associated content, the airtime of the associated content, a particular episode of the associated content, a particular episode aired or otherwise delivered at a particular time, and a combination of a television network and a day part (e.g., 9 am-11 am, daytime, or prime time). The content represented by the associated content 114 may be any content, such as online content or television content. As used herein, the term “television content” includes any entertainment-grade long-form (e.g., 30 minutes in duration or longer) multimedia (i.e., video and audio) content, irrespective of whether it actually has been delivered to viewers by a television broadcast. For example, “television content,” as that term is used herein, may be delivered to users solely online and not delivered to any users by television broadcast.

The audience model generator 110 may include, in the audience model 112, data 116 specifying one or more attributes of the audience represented by the audience model 112, and one or more values of each such attribute. Examples of attributes within the audience model 112 include the following attributes of some or all of the viewers in the corresponding audience, individually and/or in aggregate:
total number of viewers (e.g., individuals and/or households);
location(s) of viewers;
demographic attributes of viewers (such as age, gender, marital status, income, education, ethnicity, and number of children);
psychographic attributes of viewers; and
behavioral attributes of viewers (such as buying behavior and interests).

The audience model generator 110 may include, in the audience model 112, data 118 representing the total number of impressions associated with the content represented by the associated content data 114. As used herein, the term “impression” refers to a single exposure of a single person or home exposed to a single advertisement.

The audience model 112 may be used for any of a variety of purposes, such as offering advertisements for sale in connection with the content 114 associated with the audience model 112, and selling such advertisements.

The audience model generator 110 may generate the audience model 112 based on some or all of the data 108a-e using any of a variety of techniques, such as one or more of the following in any combination:
Performing nonlinear correlation of external significant factors (e.g., any one or more of time of year and any of the economic data described above) and content metadata associated with the content represented by the associated content data 114 (e.g., any one or more of ratings, genre, actors, producers of the content represented by the associated content data 114) with historical and ongoing viewing data contained within the audience model 112.
Performing statistically significant sampling of direct household viewing data (such as one or more of the return path data 108c and the ACR data 108d) to relate aggregate viewership predictions (such as the aggregate viewership predictions in the historical viewing data models 108a) to finer-grained geography-specific predictions, and then storing such finer-grained geography-specified predictions in the audience model 112.
Using aggregated household descriptive data which describes the distribution of salient characteristics across a plurality of households within finer-grained geographies (such as census tracts, municipalities, states, markets, or ZIP codes) to generate the audience attributes 116 in the audience model 112. Because detailed household data may not be available for each individual household, the audience model generator 110 may use aggregated household descriptive data to generate predictions of the characteristics of the households that watch particular content or collection of content (e.g., content broadcast by a particular network or collection of networks).

Embodiments of the system 100 of FIG. 1 and the method 200 of FIG. 2 have a variety of advantages. For example, the system 100 and method 200 enable an audience model for particular television content to be generated based on a variety of data sources, such as one or more of regression models, household profiles 108b, return path data 108c, and automatic content recognition data 108d. As a result of taking into account such a wide variety of relevant data, the system 100 and method 200 are able to generate audience models which are highly predictive of the actual audience for the associated television content and which include fine-grained details of the attributes of that audience. For example, an audience model generated by embodiments of the present invention may predict that the audience for a particular television program is likely to include (e.g., more likely than some threshold, such as more likely than 75% of the US population as a whole) men aged 18-34 having a household income of $50-$60,000 who live in a specific set of zip codes and who tend to watch prime time television on weekdays and to change channels every ten minutes, and that such an audience is predicted to deliver a particular total number of impressions (e.g., two million). In contrast, existing audience models typically specify only known attributes of the audience that actually watched particular content, rather than specifying predictions of which audience will likely watch particular content in the future.

One benefit of the ability to generate finer-grained and more accurate audience models is that such models may be used to provide more fine-grained and accurate information to buyers of advertising than the information traditionally provided in connection with advertisement placement opportunities, such as television airtimes. For example, audience models generated by embodiments of the present invention (or information derived therefrom) may be provided to buyers of advertising. This enables buyers to make their purchasing decisions based on information which is both more specific and more relevant to their purchasing decisions, thereby making it easier for buyers to make such purchasing decisions. For example, an advertising buyer who is required to target women aged 18-34 who sees an offer to sell an advertisement placement opportunity that is associated with an audience containing women aged 18-34 may easily recognize that such an opportunity satisfies the purchasing requirements, without the need to draw inferences about the composition of the audience from attributes (such as airtime) which are not directly expressed in terms of attributes of the audience. As a result, the buyer may both be more likely to purchase such an opportunity and may be more likely to pay a higher price for such an opportunity than if the opportunity were not expressed directly in terms of attributes of the associated audience.

Predictive audience models generated by embodiments of the present invention, such as the audience model 112, may be used for purposes other than buying and selling advertising opportunities. For example, such predictive audience models may be used to predict the future performance of a television program, which may be useful when deciding how to manage the program lineup for a television network.

In another embodiment, a system provides a virtual marketplace in which an advertising opportunity (such as a television advertising opportunity) is expressed in terms of an audience model representing an audience associated with the advertising opportunity. The system provides potential buyers of a particular advertising opportunity with information about the audience model associated with that advertising opportunity. The system sells advertising opportunities to buyers using any of a variety of transaction semantics. A buyer who purchases a particular advertising opportunity purchases the opportunity to present an advertisement to an audience represented by the audience model associated with the purchased advertising opportunity.

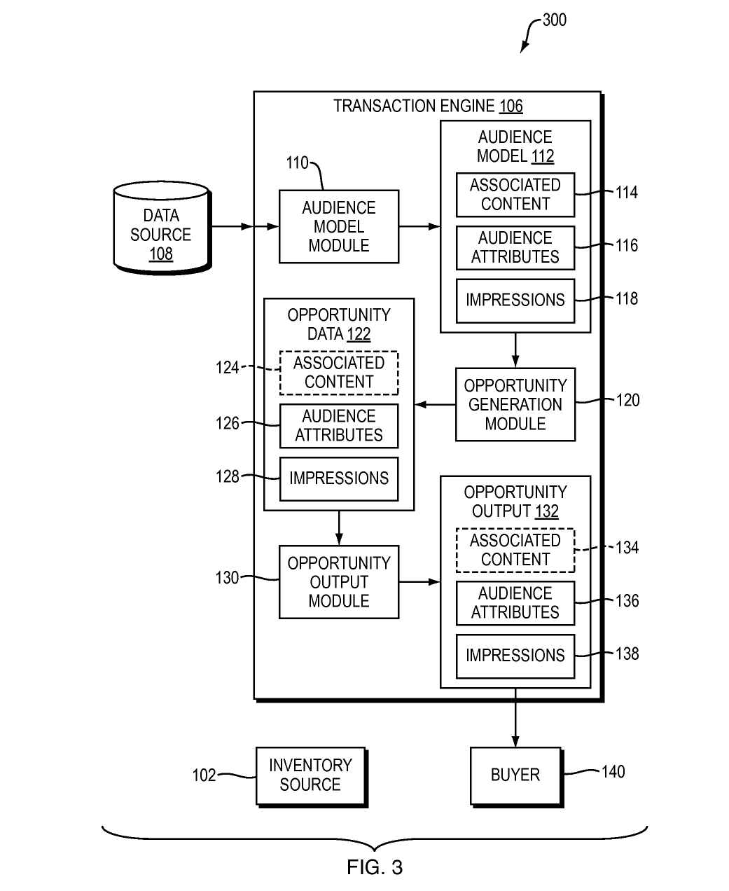

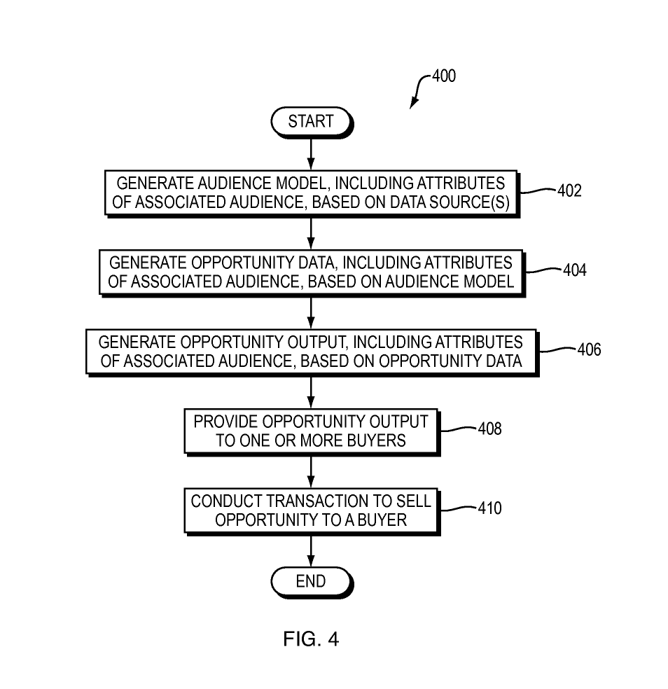

For example, referring to FIG. 3, a dataflow diagram is shown of a system 300 for representing and expressing advertising opportunities in terms of audience models representing the audiences associated with those advertising opportunities and for selling such advertising opportunities. Referring to FIG. 4, a flowchart is shown of a method 400 performed by the system 300 according to one embodiment of the present invention.

The system 300 includes an inventory source 102. Examples of the inventory source 102 include a television, computer, tablet, or smartphone. These are merely examples and do not constitute limitations of the present invention. More generally, the inventory source 102 may be any device and/or medium which is capable of (e.g., contains means for) delivering an advertisement to a recipient of the advertisement (e.g., a television viewer). The inventory source 102 may, for example, be or include one or more output devices for producing output to the advertisement recipient, such as a screen for producing visual output and/or a speaker for producing auditory output. The inventory source 102 may use one or more such output devices to produce output as part of delivering the advertisement to the advertisement recipient within the advertising placement opportunity. Additionally or alternatively, the inventory source 102 may, for example, include one or more input devices for receiving input from the advertisement recipient, such as any one or more of the following: a keyboard, a touchscreen, a mouse, a track pad, and a microphone. The inventory source 102 may use such input devices to receive input as part of delivering the advertisement to the advertisement recipient, as in the case of an interactive advertisement.

The inventory source 102 may be, be a component of, or contain a computer or a computing device, as those terms are used herein. The inventory source 102 may receive data, such as advertisements, over a network, such as the public Internet or a private intranet. For example, the inventory source 102 may receive an advertisement over a network and then display some or all of the advertisement to the advertisement recipient using one or more output devices.

Traditionally, the term “advertisement placement opportunity” (also known as an “advertising opportunity”) refers to a defined opportunity to provide an advertisement to one or more viewers via one or more inventory sources. An individual such opportunity may be referred to as an “avail,” while multiple such opportunities may collectively be referred to as “inventory.” Examples of traditional advertisement placement opportunities includes a quarter-page portion of a particular page in a particular issue of a particular magazine, and a 30-second slot within a particular episode of a particular television program. Traditionally, during the process of selling traditional television advertisements, a television advertisement placement opportunity is expressed to advertising buyers in terms of the time during which the buyer's advertisement will air if the buyer purchases the advertisement placement opportunity. In contrast, and as explained in more detail below, embodiments of the present invention express advertisement placement opportunities in terms of an audience model representing an audience (e.g., an actual or predicted audience) associated with the advertisement placement opportunity.

The system 300 of FIG. 3 includes a transaction engine 106, which includes audience model 112. The audience model 112 may, for example, be generated by the audience model module 110 in any of the ways disclosed herein in connection with FIGS. 1 and 2. In general, the audience model 112 may be associated with some particular content, such as some particular television content.

The audience attribute data 116 in the audience model 112 may be generated in any of a variety of ways. For example, an audience model module 110 may generate the audience attribute data 116 in the audience model 112 based on any data source 108 (FIG. 4, operation 402). The data source 108 shown in FIG. 3 may, for example, include any one or more of the data sources 104a-e shown in FIG. 1. The audience model module 110 may update the audience model 112 over time based on changes and/or additions to data received from the data source 108. The audience attribute data 116 and impression data 118 shown in FIG. 3 may, for example, be generated, represented, and stored in any of the ways disclosed herein in connection with FIGS. 1 and 2.

Although only a single audience model 112 is shown in FIG. 3 for ease of illustration, the system 300 may include any number of audience models 112. Each such audience model may represent an audience for corresponding content. For example, one audience model may represent an audience for one television program, while another audience model may represent a different audience for a different television program. As another example, one audience model may represent an audience for one network or collection of networks, while another audience model may represent a different audience for another network or collection of networks. As a result, the associated content data 114, audience attribute data 116, and impression data 118 may differ from audience model to audience model.

The system 300 may represent opportunities to insert or deliver an advertisement within or adjacent to television content in terms of their associated audience characteristics and offered for sale in a marketplace as blocks of one or more impressions, based on the addressability of the opportunity (i.e., the ability to address the opportunity to a specific portion of the viewing population, such as a particular household).

For example, the transaction engine 106 may include an opportunity generation module 120, which may generate opportunity data 122 representing a particular advertisement placement opportunity (FIG. 4, operation 404). The opportunity generation module 120 may generate the opportunity data 122 based on some or all of the audience model 112. The advertisement placement opportunity represented by the opportunity data 122 may be an advertisement placement opportunity associated with the content represented by the associated content data 114. For example, the advertisement placement opportunity represented by the opportunity data 122 may be an opportunity to place an advertisement within (temporally and/or spatially) or adjacent to (temporally and/or spatially) the content represented by the associated content data 114.

The opportunity data 122 includes audience attributes 126, which represent attributes of the audience associated with the opportunity represented by the opportunity data 122. The audience attributes 126 in the opportunity data 122 may be the same as, a subset of, or otherwise derived from the audience attributes 116 in the audience model 112. In general, the audience attributes 126 may be generated to represent one or more attributes of the actual audience that views (or the predicted audience that is expected to view) the advertisement that is placed to fill the advertisement placement opportunity represented by the opportunity data 122.

The opportunity data 122 also includes impression data 128, which represents the number of impressions offered for sale as part of the opportunity represented by the opportunity data 122. The impression data 128 may be the same as or otherwise be derived from the impression data 118 in the audience model 112.

The opportunity data 122 may, but need not, also include associated content data 124 specifying content associated with the opportunity represented by the opportunity data 122. The associated content data 114 may be the same as or otherwise be derived from the associated content data 114 in the audience model 112. The associated content data 114 may, for example, be any data that is conventionally used to specify content with an advertisement placement opportunity, such as the airtime of television content. Although the opportunity data 122 may include the associated content data 124 as a supplement to the audience attribute data 126 and the impression data 128, the opportunity data 122 need not include the associated content data 124.

Although only one set of opportunity data 122 is shown in FIG. 3 for purposes of example, the opportunity generation module 120 may generate any number of sets of opportunity data. For example, the opportunity generation module 120 may generate multiple sets of opportunity data, which may be the same as or differ from each other, based on a single audience module. As another example, the opportunity generation module 120 may generate multiple sets of opportunity data based on different audience models 112.

The transaction engine 106 may also include an opportunity output module 130, which may generate opportunity output 132 based on some or all of the opportunity data 122 (FIG. 4, operation 406). The opportunity output module 130 may provide the opportunity output 132 to one or more buyers (such as buyer 140) for use in a bidding process or other transaction for purchasing the advertisement placement opportunity represented by the opportunity output 132 and the opportunity data 122 (FIG. 4, operation 408). Although only one buyer 140 is shown in FIG. 3 for purposes of example, the system 100 may include any number of buyers. Furthermore, the opportunity output module 130 may provide the opportunity output 132 to a buyer (such as the buyer 140) by providing the opportunity output 132 to a computing device associated with (e.g., owned and/or used by) the buyer. Therefore, any reference herein to providing data (such as the opportunity output 132) to a buyer should be understood to refer to providing the data to a computing device associated with the buyer, and any reference herein to receiving data from a buyer should be understood to refer to receiving the data from a computing device associated with the buyer.

The opportunity output 132 includes audience attributes 136, which represent attributes of the audience associated with the opportunity represented by the opportunity output 132 (and, therefore, the opportunity data 122). The audience attributes 136 in the opportunity output 132 may be the same as, a subset of, or otherwise derived from the audience attributes 126 in the opportunity data 122. In general, the audience attributes 136 may be generated to represent one or more attributes of the audience that views (or the predicted audience that is expected to view) the advertisement that is placed to fill the advertisement placement opportunity represented by the opportunity data 122.

By providing the opportunity output 132 to the buyer 140, the system 100 informs the buyer 140 of attributes of the audience associated with the advertisement placement opportunity that is for sale. This illustrates how the system 100 differs from conventional systems for selling advertisement placement opportunities, which express such opportunities to buyers in terms of the television airtime associates with the opportunities. In contrast, the system 100 expresses advertisement placement opportunities to buyers in terms of the attributes of the audience associated with such opportunities, in the form of the audience attributes 136.

The opportunity output 132 also includes impression data 138, which represents the number of impressions offered for sale as part of the opportunity represented by the opportunity data 122. The impression data 138 may be the same as or otherwise be derived from the impression data 128 in the opportunity data 122.

The opportunity output 132 may, but need not, also include associated content data 134 specifying content associated with the opportunity represented by the opportunity data 122. The associated content data 134 may be the same as or otherwise be derived from the associated content data 124 in the opportunity data 122. The associated content data 134 may, for example, be any data that is conventionally used to specify content with an advertisement placement opportunity, such as the airtime of television content. Although the opportunity output 132 may include the associated content data 134 as a supplement to the audience attribute data 134 and the impression data 138, the opportunity output 132 need not include the associated content data 134.

Although only one set of opportunity output 132 is shown in FIG. 1 for purposes of example, the opportunity output module 130 may generate any number of sets of opportunity output. For example, the opportunity output module 130 may generate multiple copies of the same opportunity output 132 and provide each such copy to a distinct buyer. As another example, the opportunity output module 130 may generate multiple sets of opportunity output, one for each set of distinct opportunity data 122.

The opportunity output 132 may take any of a variety of forms. For example, a computing device (such as a computing device used by the buyer 140) may render or otherwise manifest the opportunity output 132 to the buyer in the form of textual descriptions, tables, charts, graphs, or other visual representations of one or more of the audience attributes 136, impression data 138, and associated content 134, in any combination. Additionally or alternatively, the opportunity output 132 may include output which is not human-readable and which the opportunity output module 130 provides as digital data to another device, e.g., via an Application Program Interface (API). As another example, the opportunity output module 130 may store the opportunity output 132 in a data file, which may be manually processed by the buyer 140 or other user.

The system 100 may sell the advertisement placement opportunity represented by the opportunity output 132 and the opportunity data 122 to a buyer (such as the buyer 140) in any of a variety of ways (FIG. 4, operation 410). For example, the system 100 may conduct a purchase and sale transaction using any of a variety of transaction semantics, such as:
An open auction in which multiple sellers make multiple advertisement placement opportunities available to multiple buyers (such as buyer 140). An auction is conducted to sell individual offered opportunities to the available buyers. The system 100 may or may not provide the associated content data 134 for the opportunities to the buyers.
A private auction, in which a single seller designates multiple buyers. An auction is conducted to sell individual offered opportunities from the single seller to the available buyers. The system 100 may or may not provide the associated content data 134 for the opportunities to the buyers.
A direct rate card, in which a single seller designates a single buyer and specifies a pre-negotiated set of rates for advertisement placement opportunities offered by the seller. For each offered advertisement placement opportunity, the system 100 provides the audience attributes 136, number of impressions 138, and associated content data 134 to the buyer.

The result of any of these kinds of transactions is the purchase of one or more offered advertisement placement opportunities by one or more buyers. As described above, each such advertisement placement opportunity is defined in terms of an actual and/or expected audience associated with that advertisement placement opportunity (and possibly also in terms of the content associated with that advertisement placement opportunity). For each purchased advertisement placement opportunity, the system 100 provides the advertisement(s) to be placed in that opportunity to an appropriate system for delivering the advertisement(s) within the opportunity.

Embodiments of the system 300 of FIG. 3 and the method 400 of FIG. 4 have a variety of advantages. For example, the system 300 and method 400 enable advertisement placement opportunities to be expressed to buyers in terms of attributes of the audiences associated with those opportunities. This enables more direct and relevant information to be provided to buyers than the information traditionally provided in connection with advertisement placement opportunities, such as television airtimes. Advertising buyers purchase advertisement placement opportunities for the purpose of targeting advertisements at audiences who are likely to be purchase the products and services advertised by such advertisements. Information about the attributes of the targeted audience, therefore, is highly relevant to the purchasing decisions of advertisement buyers. Traditionally, however, information about the audience associated with each individual television advertisement placement opportunity has been difficult or impossible to generate and provide to advertisement buyers. As a result, in traditional television advertising purchasing transactions, information about the audience associated with each advertising opportunity has been provided to buyers only vaguely and indirectly in the form of television airtime information. Advertisement buyers have therefore needed to draw inferences from airtime information about the audience that is likely to view a particular television program during a specified airtime. Such inferences are difficult to make with high accuracy. As a result, the traditional process of selling and purchasing television advertisement placement opportunities has been fraught with imperfect information about the audiences associated with advertising opportunities.

In contrast, embodiments of the system 300 and method 400 provide information about advertising opportunities to buyers directly in the form of information describing attributes of an actual audience that views (or a predicted audience that is expected to view) the advertisement that is placed within each opportunity. This enables buyers to make their purchasing decisions based on information which is both more specific and more relevant to their purchasing decisions, thereby making it easier for buyers to make such purchasing decisions. For example, an advertising buyer who is required to target women aged 18-34 who sees an offer to sell an advertisement placement opportunity that is associated with an audience containing women aged 18-34 may easily recognize that such an opportunity satisfies the purchasing requirements, without the need to draw inferences about the composition of the audience from attributes (such as airtime) which are not directly expressed in terms of attributes of the audience. As a result, the buyer may both be more likely to purchase such an opportunity and may be more likely to pay a higher price for such an opportunity than if the opportunity were not expressed directly in terms of attributes of the associated audience.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Embodiments of the present invention may transmit and/or receive data and/or instructions over one or more networks, such as the Internet. For example, the audience model generator 110 may receive data from any one or more of the data sources 108a-e over one or more networks, and provide the audience model 112 to another component (such as the transaction engine 106) over one or more networks. More generally, any data disclosed herein as being provided from one component to another may be so provided by transmitting and receiving such data over one or more networks, such as the Internet. Such networks may include, singly or in any combination, a digital communication network (such as a network that transmits data using the Internet Protocol) and/or a cable television network. Such data may be transmitted by wire or wirelessly, in any combination.

Embodiments of the present invention include features which are only possible and/or feasible to implement with the use of one or more computers, computer processors, and/or other elements of a computer system. Such features are either impossible or impractical to implement mentally and/or manually. For example, the audience model generator 110 may receive and processes return path data 108c. The return path data 108c may be encoded and stored in a form which is neither understandable by nor processable by a human. Similarly, the audience model generator 110 may receive and process automatic content recognition data 108d. The automatic content recognition data 108d may be encoded and stored in a form which is neither understandable by nor processable by a human. Furthermore, the audience model generator 110 may produce the audience model 112 in an amount of time (e.g., within 1 second, 10 seconds, or 1 minute of receiving some or all of the inputs 108a-e) in which it would not be possible for a human to produce the audience model 112 based on the inputs 108a-e. As yet another example, the audience model 112 may be encoded and stored in a form which is neither understandable by nor processable by a human. For at least these reasons, embodiments of the present invention are only possible and/or feasible to implement with the use of one or more computers, computer processors, and/or other elements of a computer system.

As another example, the opportunity generation module 120 may receive and process the audience model 112, which may be encoded and stored in a form which is neither understandable by nor processable by a human. Similarly, the opportunity data 122 may be encoded and stored in a form which is neither understandable by nor processable by a human. The act of generating the opportunity data 122 based on the audience model 112 may, therefore, be impossible for a human to perform. As another example, the opportunity generation module 120 may produce the opportunity data 122 in an amount of time (e.g., within 1 second, 10 seconds, or 1 minute of receiving the audience model 112) in which it would not be possible for a human to produce the opportunity data 122 based on the audience model 112. As yet another example, the opportunity generation module 120 may produce many sets of opportunity data 122 (based on the same or different audience models 112) more rapidly than could be performed by a human. For example, the opportunity generation module 120 may generate five, ten, one hundred, or one thousand sets of opportunity data 122 (which may differ from each other) in less than a second. For at least these reasons, embodiments of the present invention are only possible and/or feasible to implement with the use of one or more computers, computer processors, and/or other elements of a computer system.

Embodiments of the present invention may improve a computer. For example, embodiments of the present invention may be implemented as an improved computer, or a part thereof (such as an improved computer processor and/or memory). For example, an embodiment of the present invention may be a computing device which is adapted to perform the functions of the audience model generator 110. Such a computing device is improved in comparison to a general-purpose computer which is not adapted to perform the functions of the audience model generator 110, in at least the sense that such a computing device has all of the benefits of the audience model generator 110, whereas the general-purpose computer does not. As another example, an embodiment of the present invention may be a computing device which is adapted to perform the functions of the opportunity generation module. Such a computing device is improved in comparison to a general-purpose computer which is not adapted to perform the functions of the opportunity generation module 120, in at least the sense that such a computing device has all of the benefits of the opportunity generation module, whereas the general-purpose computer does not.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored on at least one non-transitory computer-readable medium, the method comprising:
(A) generating an audience model representing at least one attribute of an audience associated with particular television content, the audience model including first audience attribute data representing at least one value of at least one attribute of the audience associated with the television content;
(B) generating opportunity data representing an advertisement placement opportunity associated with the television content, wherein the opportunity data includes second audience attribute data derived from the first audience attribute data; and
(C) generating opportunity output based on the opportunity data, wherein the opportunity output includes third audience attribute data derived from the second audience attribute data.

2. The method of claim 1, further comprising:
(D) providing the opportunity output to a computing device associated with a buyer.

3. The method of claim 2, further comprising:
(E) conducting a transaction with the buyer, comprising selling the advertisement placement opportunity to the buyer.

4. The method of claim 3, wherein the transaction comprises an auction.

5. The method of claim 1, wherein the second audience attribute data represent a predicted audience of the particular television content.

6. The method of claim 1, wherein the second audience attribute data is the same as the first audience attribute data.

7. The method of claim 1, wherein the third audience attribute data is the same as the second audience attribute data.

8. The method of claim 1, wherein (A) comprises:
(A)(1) receiving a plurality of data sources including at least two of: a regression model relating to at least one television viewing audience, a plurality of household profiles of the at least one television viewing audience, return path data from a plurality of television viewing devices, and automatic content recognition data received from the plurality of television viewing devices; and
(A)(2) generating the audience model based on at least two of the plurality of data sources received in (A)(1).

9. The method of claim 8, wherein (A)(1) comprises receiving historical viewing data, wherein the historical viewing data includes the regression model.

10. The method of claim 9, wherein the historical viewing data includes data representing an average number of televisions tuned into a particular program or a particular network during a particular time frame.

11. The method of claim 9, wherein the historical viewing data includes data representing a number of unique households reporting at least one minute of viewing for a particular time frame and classification.

12. The method of claim 8, wherein each of the plurality of household profiles includes a household identifier which uniquely identifies a household represented by that household profile.

13. The method of claim 8, wherein the return path data includes data indicating which channel a particular set-top box is tuned to at a particular point in time.

14. The method of claim 8:
wherein (A)(1) further comprises receiving data from an external source; and
wherein (A)(2) comprises generating the audience model based on at least two of the plurality of data sources received in (A)(1) and the data received from the external source.

15. The method of claim 14, wherein the data received from the external source comprises economic data.

16. The method of claim 14, wherein the data received from the external source comprises environmental data.

17. The method of claim 8, wherein (A)(2) comprises including, in the audience model, data representing the particular television content associated with the audience.

18. The method of claim 8, wherein (A)(2) comprises including, in the audience model, data representing a plurality of attributes of the audience.

19. The method of claim 8, wherein (A)(2) comprises including, in the audience model, data representing a total number of impressions associated with the particular television content, wherein each impression is a single exposure of a single person or home to a single advertisement.

20. A system comprising at least one non-transitory computer-readable medium containing computer program instructions executable by at least one computer processor to perform a method, the method comprising:
(A) generating an audience model representing at least one attribute of an audience associated with particular television content, the audience model including first audience attribute data representing at least one value of at least one attribute of the audience associated with the television content;
(B) generating opportunity data representing an advertisement placement opportunity associated with the television content, wherein the opportunity data includes second audience attribute data derived from the first audience attribute data; and
(C) generating opportunity output based on the opportunity data, wherein the opportunity output includes third audience attribute data derived from the second audience attribute data.

21. The system of claim 20, further comprising:
(D) providing the opportunity output to a computing device associated with a buyer.

22. The system of claim 21, further comprising:
(E) conducting a transaction with the buyer, comprising selling the advertisement placement opportunity to the buyer.

23. The system of claim 22, wherein the transaction comprises an auction.

24. The system of claim 20, wherein the second audience attribute data represent a predicted audience of the particular television content.

25. The system of claim 20, wherein the second audience attribute data is the same as the first audience attribute data.

26. The system of claim 20, wherein the third audience attribute data is the same as the second audience attribute data.

27. The system of claim 20, wherein (A) comprises:
(A)(1) receiving a plurality of data sources including at least two of: a regression model relating to at least one television viewing audience, a plurality of household profiles of the at least one television viewing audience, return path data from a plurality of television viewing devices, and automatic content recognition data received from the plurality of television viewing devices; and
(A)(2) generating the audience model based on at least two of the plurality of data sources received in (A)(1).

28. The system of claim 27, wherein (A)(1) comprises receiving historical viewing data, wherein the historical viewing data includes the regression model.

29. The system of claim 28, wherein the historical viewing data includes data representing an average number of televisions tuned into a particular program or a particular network during a particular time frame.

30. The system of claim 28, wherein the historical viewing data includes data representing a number of unique households reporting at least one minute of viewing for a particular time frame and classification.

31. The system of claim 27, wherein each of the plurality of household profiles includes a household identifier which uniquely identifies a household represented by that household profile.

32. The system of claim 27, wherein the return path data includes data indicating which channel a particular set-top box is tuned to at a particular point in time.

33. The system of claim 27:
wherein (A)(1) further comprises receiving data from an external source; and
wherein (A)(2) comprises generating the audience model based on at least two of the plurality of data sources received in (A)(1) and the data received from the external source.

34. The system of claim 33, wherein the data received from the external source comprises economic data.

35. The system of claim 33, wherein the data received from the external source comprises environmental data.

36. The system of claim 27, wherein (A)(2) comprises including, in the audience model, data representing the particular television content associated with the audience.

37. The system of claim 27, wherein (A)(2) comprises including, in the audience model, data representing a plurality of attributes of the audience.

38. The system of claim 27, wherein (A)(2) comprises including, in the audience model, data representing a total number of impressions associated with the particular television content, wherein each impression is a single exposure of a single person or home to a single advertisement.
